(19) United States
(12) Patent Application Publication
(10) Pub. No.: US 2018/0253430 A1
(43) Pub. Date: Sep. 6, 2018

(54) Tagging, Tracking, and Cataloging Articles of Clothing

(71) Applicants: Cristian Grigorescu, Bellevue, WA (US); Deepak Mani, Sammamish, WA (US)

(72) Inventors: Cristian Grigorescu, Bellevue, WA (US); Deepak Mani, Sammamish, WA (US)

(21) Appl. No.: 15/912,745

(22) Filed: Mar. 6, 2018

Related U.S. Application Data
(60) Provisional application No. 62/467,670, filed on Mar. 6, 2017.

(51) Int. Cl. G06F 17/30; G06K 19/06; H04L 29/08; G06Q 50/00

(52) U.S. Cl. CPC G06F 17/30035; G06K 19/06037; G06Q 50/01; H04L 67/22; G06F 17/30058

(57) ABSTRACT

Devices, systems, and methods are described herein for tagging, tracking, and cataloging articles of clothing. In one embodiment, a method for identifying clothing includes identifying, by an electronic device, a tag of an article of clothing. The method further includes retrieving, by the electronic device, information regarding the article of clothing. Additionally, the method includes displaying at least a portion of the retrieved information on a display of the electronic device. Additional methods include authenticating articles of clothing, cataloging articles of clothing within a digital closet, sharing clothing choices or catalogs of clothing, and identifying trends in clothing choices.

The application claims the benefit of U.S. Provisional Patent Application No. 62/467,670, filed Mar. 6, 2017, which is hereby incorporated by reference in its entirety.

### FIELD

The following disclosure relates to the usage of tags to identify apparel after they have been sold, in conjunction with an application ecosystem that enables users to: (1) identify the articles of clothing they possess and retrieve wear and care information about each article of clothing; (2) get recommendations on what to wear based on their inventory and other context aware parameters like calendar, social media, location, weather, contacts, or trends; or (3) buy related accessories/apparel from online marketplaces, physical marketplaces, or storefronts based on recommendations.

### BACKGROUND

Currently, once a person purchases an article of clothing, keeping a digital catalog of the clothing may be difficult. Additionally, it may be difficult to gain an insight into what a user can wear, how to take care of an item, or even buy accessories or related apparel without losing the current context. In current situations, buying clothes within an online marketplace may consider what a user has previously viewed, but not what the user has within their wardrobe or closet. Therefore, a lot of insight based on contextual awareness goes missing into providing recommendations to the end user. There is no single application or method for users to answer questions such as: “What should I wear today?” or “What should I wear to the event tonight?”. Additionally, there is no application or method for users to answer questions such as: “What is my oldest piece of clothing?” or “What article of clothing have I worn the most?”. There is also no straightforward solution for users to purchase a piece of clothing that is currently being worn by someone they see or know without needing to figure out the details of that piece using its physical tag or asking the wearer (and most likely not getting any info, because the wearer might not know or remember).

### SUMMARY

Devices, systems, and methods are described herein for tagging, tracking, and cataloging articles of clothing. In one embodiment, a method for identifying clothing includes identifying, by an electronic device, a tag of an article of clothing; retrieving, by the electronic device, information regarding the article of clothing; and displaying at least a portion of the retrieved information on a display of the electronic device.

In a second embodiment, a method of cataloging an article of clothing includes identifying, by an electronic device, a tag of an article of clothing; retrieving, by the electronic device, information regarding the article of clothing; and storing at least a portion of the retrieved information in a catalog representing a collection of articles of clothing of a user of the electronic device.

In a third embodiment, a method of providing a recommended article of clothing (including clothing accessories) for a user to wear includes receiving, by an electronic device, a request to recommend an article of clothing to wear; retrieving, by the electronic device, information affecting the user's clothing choices; retrieving, by the electronic device, a digital closet representing a collection of articles of clothing of the user of the electronic device; determining, by the electronic device, the recommended article of clothing based on the digital closet and the information affecting the user's clothing choices; and displaying the recommended article of clothing on a display of the electronic device.

In a fourth embodiment, a method of tracking an article of clothing includes creating a tag for the article of clothing, the tag comprising information regarding an authenticity of the article of clothing; saving the information regarding the authenticity of the article of clothing in a database separate from the article of clothing; receiving, by the database, a request regarding the authenticity of the article of clothing; and transmitting, by a processor of the database, a verification of the authenticity of the article of clothing.

In a fifth embodiment, a method of identifying clothing includes identifying, by an electronic device, a tag of an article of clothing; and transmitting, by the electronic device, information identifying that a user of the electronic device is wearing or planning to wear the article of clothing.

In a sixth embodiment, a method of tracking trends in clothing includes receiving, by a database, information from a plurality of electronic devices identifying that users of the plurality of electronic devices are wearing or planning to wear various articles of clothing; determining, by a processor of the database, one or more trends in clothing being worn based on the received information; and transmitting, by the processor, at least one trend to an end user.

### BRIEF DESCRIPTION OF THE DRAWINGS

Exemplary embodiments are described herein with reference to the following drawings.

FIG. 1 depicts an example of an electronic device scanning a tag.

FIG. 2 depicts an example of an electronic device displaying information acquired from a scanned tag.

FIG. 3 depicts an example of an application menu on an electronic device for tagging, adding, or viewing articles of clothing.

FIG. 4 depicts an example of an electronic device displaying product care information of an article of clothing saved within a user's digital closet.

FIG. 5 depicts an example of an electronic device displaying product information of an article of clothing saved within a user's digital closet.

FIG. 6 depicts an example of an application on an electronic device displaying a recommended article of clothing.

FIG. 7 illustrates an example flowchart for identifying information for an article of clothing.

FIG. 8 illustrates an example flowchart for cataloging an article of clothing.

FIG. 9 illustrates an example flowchart for recommending an article of clothing for a user to wear.

FIG. 10 illustrates an example flowchart for tracking and authenticating an article of clothing.

FIG. 11 illustrates an example flowchart for identifying clothing a user is wearing or planning to wear.

FIG. 12 illustrates an example flowchart for tracking trends in clothing.

FIG. 13 depicts a block diagram of a computing environment in accordance with one example for implementation of the disclosed methods or one or more electronic devices.

### DETAILED DESCRIPTION

Disclosed herein are devices, systems, and methods for tagging articles of clothing to enable a smart-wearable ecosystem to enrich the lives of people who are looking to get more out of what they wear while enabling manufacturers to get insights on how the clothes are being worn after sales, to respond quickly to trends.

Such devices, systems, and methods are advantageous for several reasons. First, they enable a way for people to possess digital information about what they wear. Second, they enable a way for people to access the care information for their clothing digitally. Third, they eliminate the need to retain the physical tags on an article of clothing. Fourth, they provide context-aware wear and care recommendations to the user, by being aware of what they have in their closet and other parameters described herein (e.g., weather, time of day, day of week, itinerary, and so on). Fifth, they enable a way to buy apparel that completes an outfit through the above defined context-aware recommendations, thereby helping increase the conversion rate of a lookup/buy flow. Sixth, they enable a digital disruption in the way clothing is defined in the industry, by making each piece of clothing a “THING”, in the Internet of Things—by associating a global unique identifier to it. Seven, they enable a way to authenticate the genuineness of an item through digital tagging/validation. Eight, there exists no ecosystem in the world today that provides all these as a complete package.

### Creating a Tag for an Article of Clothing

A physical tag may be created for an article of clothing and encoded with information relating to the article of clothing. The article of clothing may be any type of covering designed to be worn on a person's (or animal's) body or carried by the person or animal. Non-limiting examples of articles of clothing include pants, shirts, shorts, skirts, blouses, jackets, dresses, shoes, hats, bras, underwear, suits, jewelry (e.g., earrings, rings, necklaces), watches, sunglasses, coats, gloves, scarves, leggings, pocketbooks, purses, scrubs, ties, and the like.

The tag may be any form of tag now known or later developed that is configured to be read by an electronic device (e.g., by scanning an image of the tag or by detecting a transmission from the tag). In certain examples, the tag includes a barcode configured to be scanned or read by the electronic device. In some examples, the tag includes a matrix barcode or a two-dimensional barcode. The two-dimensional barcode is advantageous in representing more data per unit area (in comparison with a one-dimensional barcode). The two-dimensional barcode may use rectangles, dots, hexagons, or other geometric patterns. In some examples, the matrix or two-dimensional barcode is an Aztec code, a visual cryptogram, a data matrix, an EZcode, a high capacity color barcode, a han xin barcode, a maxicode, a NexCode, a Qode, a quick response (QR) code, a ShotCode, a SPARQCode, or any code mechanism later developed. In one particular example, the tag is a QR code.

In other examples, the tag is a smart label or smart tag. The smart label may be identifiable by near field communication (NFC), radio frequency identification (RFID), or over a personal area network (e.g., Bluetooth or Bluetooth Low Energy). In other words, the label does not need to be visibly detected by an electronic device. Instead, the label or tag may be configured to emit a low-powered signal that is detectable by the electronic device when the electronic device is placed within a certain distance of the smart label (e.g., sensor). Proximity is enough to transmit the information to the application on the electronic device. The user of the electronic device may then decide to preserve this information for future use.

The smart label or smart tag includes a transponder having a chip and antenna. The smart label may be made of paper, fabric or plastics, and prepared as a paper roll with the transponder laminated between a rolled carrier and a label media.

In some examples, the smart label is a chip label, printable label, or electronic label. A chip label may include a radio-frequency identification (RFID) label. A printable label may include a printed transistor.

In certain examples, the smart label is an electromagnetic nanosensor or a molecular nanosensor. Electromagnetic nanosensors detect changes in electromagnetic waves, taking quantum effects into account, while molecular nanosensors override functioning organic communication systems to carry a coded message. Both methods require much less energy than their larger counterparts; harvested mechanical energy from nanowire vibrations.

The information encoded within the tag may include a product description, a manufacturer, a designer, fabric content, size, brand name, logo, country of origin, wash care instructions, company website uniform resource locator (URL), or a combination thereof.

The physical tag may be added to the article of clothing by the clothing manufacturer or by a separate party. The manufacturer or separate party may add the information about the article of clothing to database or product catalog storing information for hundreds, thousands, or millions separate articles of clothing from different manufacturers.

In some examples, the manufacturer may request from the separate party (e.g., the tag designer or database developer) the tag design to print and attach to the article of clothing (or similar articles of clothing). The tag may be customized to include additional information regarding the manufacturer's label or trademark, website, description of the clothing, and the like. The tag may be printed in a similar fashion to current clothing tags. Alternatively, the tag may be screen-printed or affixed directly to a surface of the article of clothing (i.e., the tag is “tagless”).

### Identifying Tag on Article of Clothing

Following the addition of a tag to the article of clothing, the tag may be identified by an end user (e.g., the wearer or carrier of the article of clothing) using an electronic device.

The electronic device may be any computing device now known or later developed. In some examples, the electronic device is a handheld or mobile computing device such as a tablet computer, mobile or smart phone. In other examples, the electronic device is any computing device having a display screen and/or a camera. In some examples, the electronic device is a wearable electronic device configured to be worn or attached to a person's body or clothing. The wearable device may be attached to a person's shirt or jacket; worn on a person's wrist, ankle, waist, or head; or worn over their eyes or ears. Such wearable devices may include a smart watch, heart-rate monitor, activity tracker, or head-mounted display.

In certain examples, the tag is identified using an application (“app”) or computer program run on the computing device. In certain examples, the application or computer program use the camera of the electronic device to visually scan and capture the tag image. In other examples, the application or computer program may be configured to detect a wireless transmission from the smart tag (as discussed above). In this case, the electronic device running the application only needs to be placed within a distance of the smart tag to detect the transmission. That is, visual identification is not necessary. In some cases, the application may be configured to run in the background of the electronic device to detect for a transmission at a predefined interval of time (e.g., every 5 minutes, 30 minutes, 1 hour, 2 hours, etc.). When a transmission is detected, the electronic device may be configured to emit a sound or vibrate to alert the user to one or more identified articles of clothing.

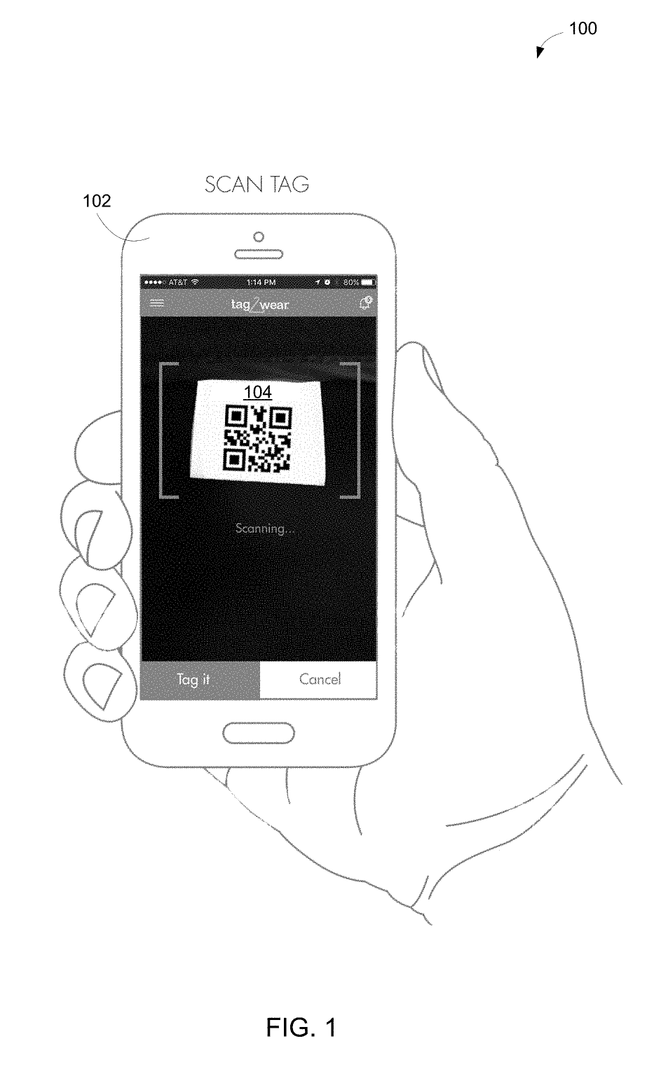

FIG. 1 depicts an example 100 of an electronic device 102 (e.g., smart phone) scanning a tag 104 of an article of clothing using a camera of the electronic device 102. Upon scanning the tag, the user of the electronic device 102 may press a physical or virtual button on the electronic device to tag the item. Alternatively, the user may activate the scanning process using a voice command that is recognizable by the electronic device or the application running on the electronic device. This scanning process may trigger the device to request or retrieve information regarding the article of clothing. Alternatively, the request or retrieval of the information may automatically take place without the user pressing a button. That is, upon visually identifying the tag, the electronic device may automatically request or retrieve the information.

The information may be retrieved from data stored within the tag itself. Alternatively, the information may be retrieved from a database stored separately from the electronic device. In other words, the electronic device may transmit a request to the database over a connected network. The database may process the request and transmit back to the electronic device the information about the article of clothing. In some examples, the information may be retrieved from a website or database maintained by the manufacturer, designer, or seller of the article of clothing. For example, the tag could link to a webpage containing the information about the article of clothing. Manufacturers, designers, sellers, and the like may decide how they want to store or label product information regarding their articles of clothing. The information may be defined and stored offline (e.g., within the tag itself) or online (e.g., using a lookup using service such as a centralized database/repository or a database/website maintained by the manufacturer).

In some examples, information may be stored in a directory or database having a plurality of different articles of clothing from various manufacturers, designers, etc. For example, the database may be a centralized database configured to process requests and transmit information for all types of articles of clothing.

The database may be an online directory for smart clothing that may identify each article of clothing that has been tagged. In other words, the information may be retrieved from a universal discovery directory interface (UDDI) for all apparel or articles of clothing using the smart tag. This may be possible by: (1) providing a global unique identifier (UID) for every article of clothing that is tagged with a “smart tag”; (2) providing Lookup, resolution, and detail application program interfaces (APIs) for the tagged articles; (3) providing a directory list for each article of clothing as applicable; and (4) assimilating a significant number of manufacturers, designers, or sellers into to the centralized system.

Following retrieval of the information, the electronic device may be configured to display the information, or at least a portion of the information, on the display screen of the electronic device. The type of information displayed may be configurable by the database providing the information or the electronic device receiving the information.

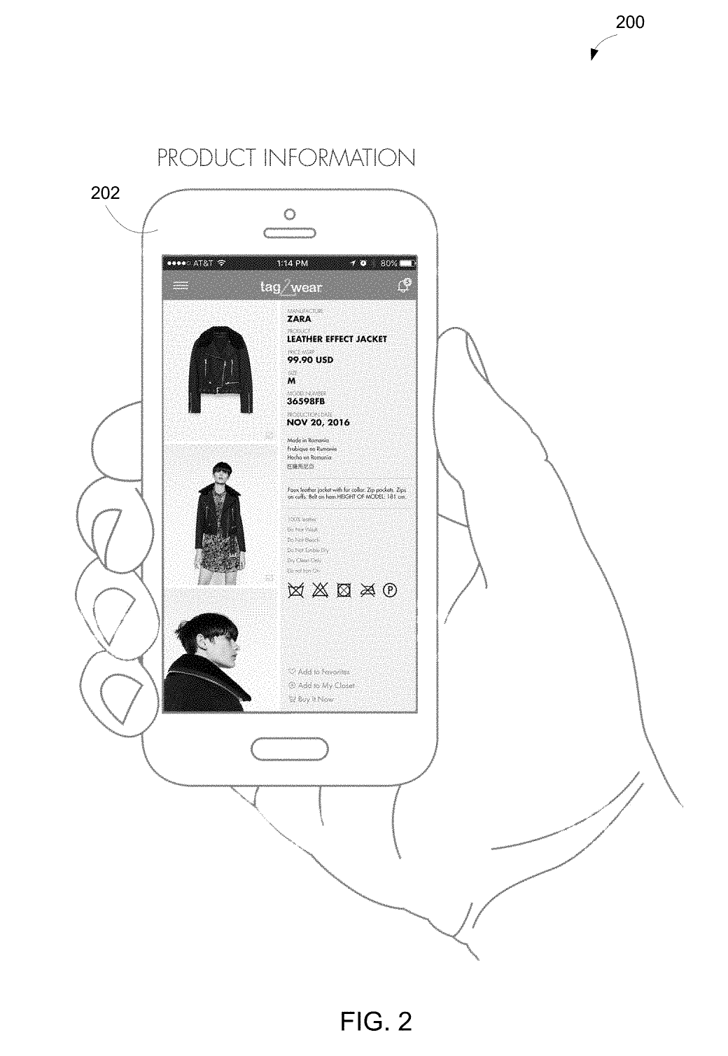

FIG. 2 depicts an example 200 of an electronic device 202 displaying information 204 acquired from a scanned tag. As shown in FIG. 2, the information may include the manufacturer, brief product description, retail cost, size, model number, production data, and wash instructions. The display may also depict certain selection items or virtual buttons for the user to choose from, including adding the article of clothing to the user's favorites, adding the article to the user's digital closet, or purchasing the item from an online retail provider (to the extent the user has scanned the tag in a physical store and has chosen to buy the article of clothing online instead, or has chosen to buy a second or replacement article of clothing).

### Cataloging Articles of Clothing

An article of clothing may be saved or cataloged within a digital closet. In other words, a user may scan a plurality of articles of clothing and save or organize them within a centralized digital location. In some examples, the digital closet is stored on the user's electronic device. In other examples, the digital closet or catalog is saved within the cloud (e.g., a database separate from and wirelessly connected to the electronic device).

In certain examples, the digital closet or catalog may be created or appended by scanning each article of clothing (as described above) and then adding the scanned item to the closet. In other words, after scanning an article of clothing, the electronic device may display an option on the display screen to add the article of clothing and product information regarding the article of clothing to the user's digital closet or catalog.

Alternatively, an article of clothing may be added to the closet by searching an online directory for the article and adding the item to the database. This may be advantageous in instances where the specific article does not have a “smart tag.”

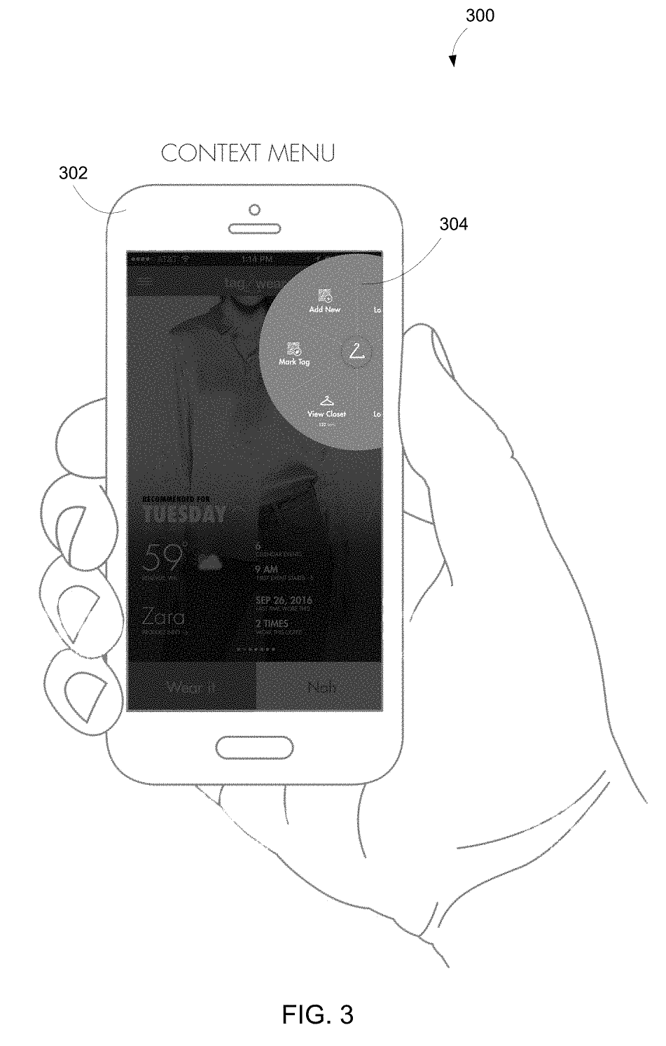

FIG. 3 depicts an example 300 of an application menu 304 on an electronic device 302 for tagging, adding, or viewing articles of clothing. In this example, the application menu 304 provides several options for adding a new article of clothing to a digital closet, marking a tag, or viewing a user's closet. Additional menu items are configurable to include certain items discussed in greater detail below (e.g., requesting a suggestion for what to wear, defining a level of sharing of viewing a user's closet, sharing a combined closet with an additional user).

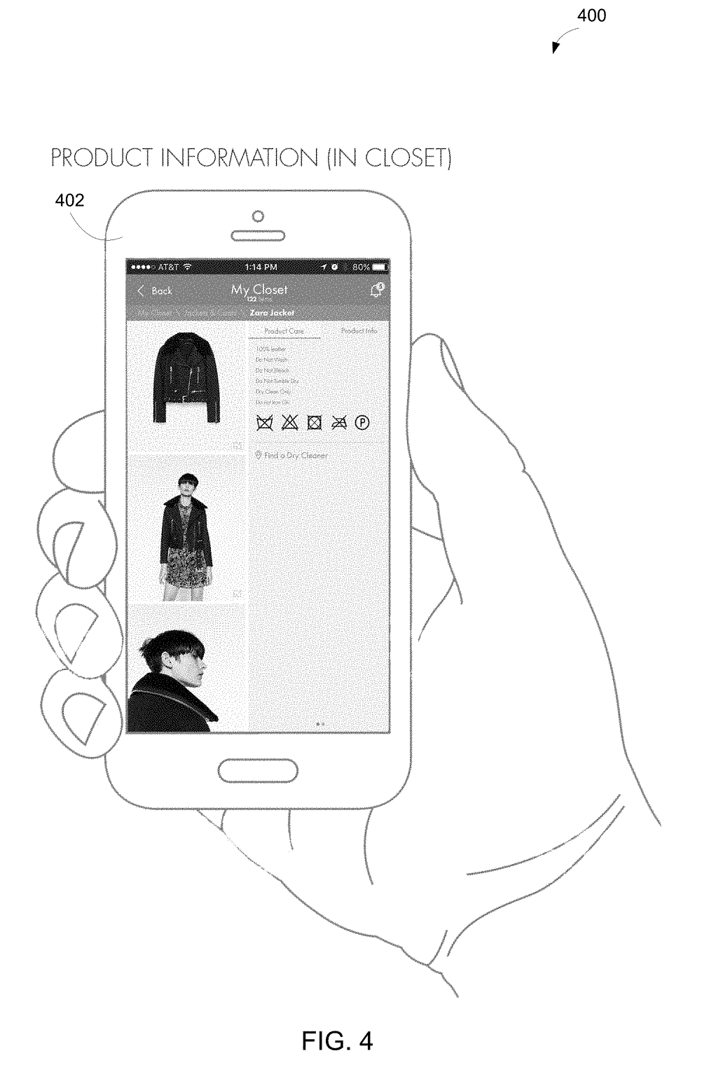

FIG. 4 depicts an example 400 of information that may be stored within a user's digital closet for a specific article of clothing. In this example 400, certain product care information may be provided. This is advantageous in providing wash care information separate from a physical tag on the article of clothing that may be damaged, illegible, removed following purchase, or nonexistent.

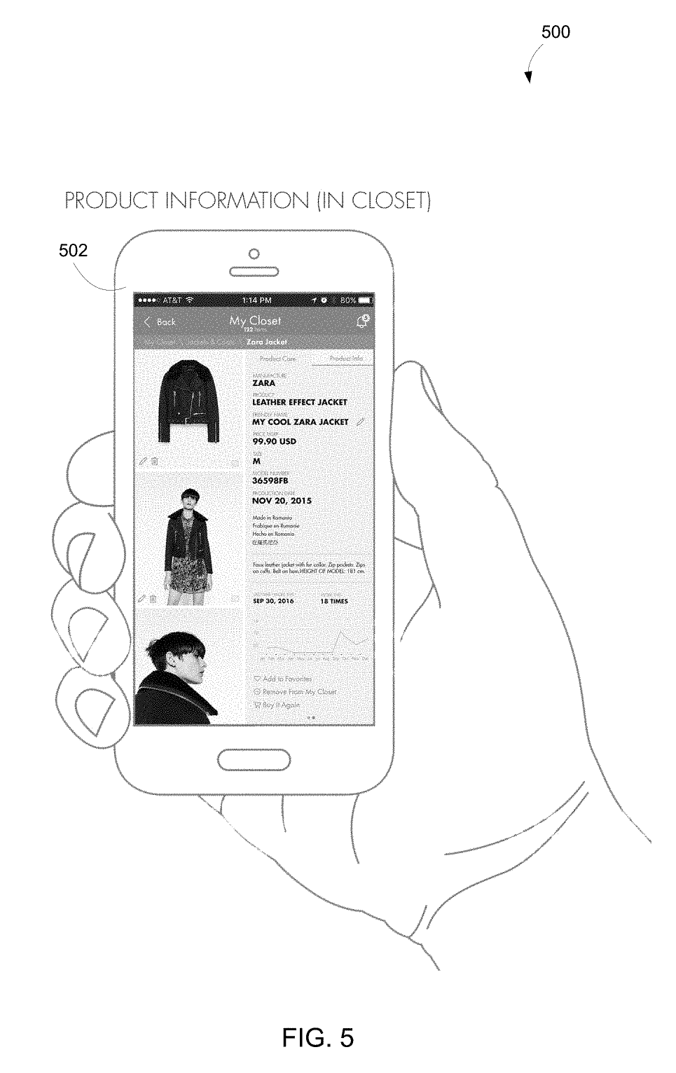

FIG. 5 depicts an example 500 of additional product information that may be stored within a user's digital closet for a specific article of clothing. In this example 500, the information includes the manufacturer, product description, retail cost, size, model number, production date, and wear information (e.g., number of times worn and last time worn).

### Sharing Digital Closet Information

In certain examples, a user may share their digital closet information with another user or group of users. The user may, using their electronic device, define a level of sharing of their digital closet with a network of users.

In some examples, this sharing may include creating a shared digital closet, wherein several users' articles of clothing are combined in a single shared closet. In some examples, users may decide to share only a fraction (e.g., less than their entire closet) with one or more additional users. This sharing may be advantageous for family members, couples, roommates, or friends that are living together.

The shared closet (e.g., family closet) may aggregate the closets of the group (e.g., family) and powers features like social likes, group member recommendations to wear, or buy related items for group (e.g., family) members. A user may choose to create a group closet by linking their digital closet with other existing users, or creating profiles for other members and associating items to each member, within a single account.

The process of creating a group closet may include: (1) requesting or adding other users of the electronic device application as part of their group or family; (2) validating the group through a confirmation pairing code sent to both users (added/adding) requesting access to each other's closets; and/or (3) marking part of a user's closet as personal or private so that certain articles of clothing do not show up in the shared list or group closet. In some examples, a user may create an additional profile within their account for a group (e.g., family) member if that person does not have their own account.

In other examples, a user may share their digital closet with friends or the public over social media. For instance, the application or software program installed on the electronic device may be configured to scan tags, identify product information from the scanned tag, create a digital closet, and share certain information of the digital closet with other users using the same application. A user may define what information is shared with others. In some cases, a user may have to accept a friend request from another user before that user is able to view their closet.

In other words, the process may include: (1) a user may select other users and share their closets with them; (2) a user may share their closets to the public using share links; and/or (3) a user may mark part of their closet as personal/private so that the portion of the closet does not show up in a shared list viewable by their friends or the public.

In some examples, the social media aspect of the application may include the ability for users to provide comments and/or acknowledgments of a user's digital closet or a specific article of clothing within the digital closet. The comment or acknowledgement may be an individual's admiration of the article of clothing (or a “like” of the article). Upon receipt of the comment from the connected user, the digital closet may be updated or appended to include the comment. For example, the product information displayed in FIGS. 3 and 4 may include additional information regarding a friend's or public's comment or like of the article.

### Recommending Articles of Clothing

In some examples, the application or computer program may be used to provide a recommendation to the user on what to wear. The process may include: (1) receiving a request from the user on what to wear (e.g., verbally or pressing a button within the application); (2) retrieving information affecting the user's clothing choices; (3) retrieving digital closet representing a collection of articles of clothing of the user of the electronic device; (4) determining a recommended article of clothing based on the digital closet and the information affecting the user's clothing choices; and (5) displaying or providing the recommended article of clothing to the user (e.g., on a display of the electronic device).

In determining what article of clothing to recommend, the application or connected cloud powered recommendation engine may analyze a user's digital closet as well as additional factors/information that could affect the recommendation. In other words, the recommendation may be context-aware (e.g., understands what exists in a user's digital closet and understands surrounding factors) in order to provide insights on what to wear.

For example, the information affecting the user's clothing choices may include factors or parameters such as: (1) a user's profile (e.g., age group, gender), (2) digital closet inventory; (3) wear information (e.g., when an article was added to the closet, when worn, number of times worn, last time worn, circumstances/event worn, people present at the time last worn); (4) a location of the user; (5) weather conditions; (6) calendar information (e.g., time of day, day of week, itinerary of the user, event attending, people attending the event, overlap with people attending event and previous events); (7) social media (e.g., clothing trends on social media sites, celebrity endorsements (and like/dislike of celebrity, comments from followers on social media regarding articles of clothing within digital closet); and/or (8) historical preferences (e.g., preferences for wearing a particular outfit to certain events or around certain people). Based on permissions from the user to access user information, the application on the electronic device or a cloud powered engine may provide detailed, context aware recommendations to the user.

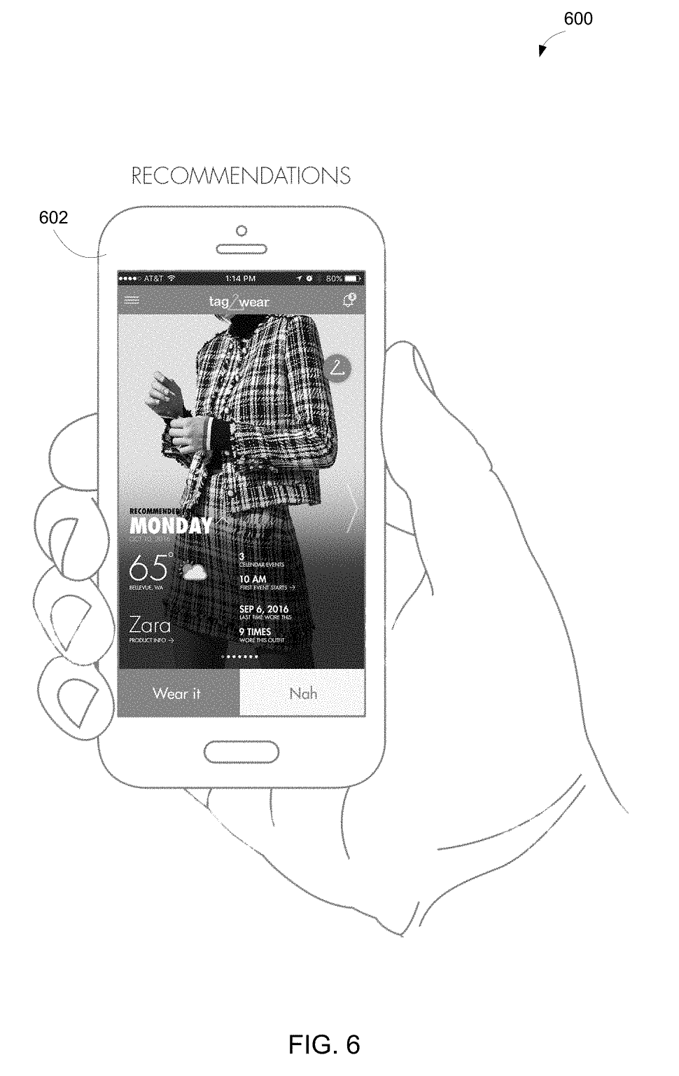

FIG. 6 depicts an example 600 of an application on an electronic device 602 displaying a recommended article of clothing. The example 600 depicts the recommended article of clothing as well as additional information such as a weather forecast, a number of events on the calendar day, a time of the first event, the last time the recommended article of clothing was worn, and the number of times the article was worn.

Following displaying the recommendation on the electronic device, a user may be able to accept or reject the recommendation. For example, FIG. 6 depicts two digital buttons or areas near the bottom of the display screen offering the options for the user to accept (“Wear It”) or reject “(Nah”) the recommendation.

When the user selects one of the options, the electronic device may receive this input, and act accordingly. For example, if a user accepts the recommendation, wear data may be added to the electronic device or transmitted to an external database or cloud that is tracking the user's wear history to include the additional day. If the user rejects the recommendation, the application on the electronic device or cloud powered engine in communication with the electronic device may determine a new recommended article of clothing based on the digital closet and the information affecting the user's clothing choices, and then display the new recommended article of clothing on the display of the electronic device. This process may be repeated until the user accepts a selection or cancels the application. In some examples, the application or cloud powered engine may take into account a user's rejection of a recommendations. That is, the rejection may become a factor in whether the article is recommended again in the future under similar circumstances.

Additionally, or alternatively, the application or cloud powered engine may provide a recommendation for a user to purchase an article of clothing to wear or compliment the user's digital closet. For example, a recommendation may be made to purchase a pair of heels or a belt that could compliment the dress recommended for the user to wear. With such a recommendation to purchase an additional item, the application may provide an option to buy the item within the application, suggest an online store to buy the item from, or suggest a physical store within a certain distance of the user (e.g., as identified by the global positioning of the electronic device) where the user can purchase the recommended article of clothing.

The process for recommending an article of clothing for purchase may be based on:
(1) online marketplaces registered or linked to the application running on the electronic device;
(2) physical storefronts registered or linked to the application running on the electronic device;
(3) a user's location (e.g., determined from the geographic location of the electronic device); or
(4) a user's proximity to a physical storefront.

### Tracking/Verifying the Authenticity of an Article of Clothing

In certain examples, a tag for an article of clothing may be encoded with product information useful to track ownership of the article of clothing and verify its authenticity. The process may include creating the tag having information regarding the authenticity of the article and saving the information in a database. Creation of the tag may include encoding the information using blockchain into the tag.

When a request is made to the database to verify the article's authenticity, the database may transmit the verification (or lack thereof).

In some examples, the database may receive an update regarding the ownership or location of an article of clothing. In such an instance, the database may be amended or updated to include the new information.

The database may be a centralized or distributed database. A distributed database is a database in which storage devices are not all attached to a common processor. The distributed database may be stored in multiple computers, located in the same physical location; or may be dispersed over a network of interconnected computers. A distributed database system may include loosely coupled sites that share no physical components.

### Tracking Wear History

In certain examples, the electronic device may be configured to identify a tag on an article of clothing and then transmit information identifying that the user is wearing or planning to wear the article of clothing. At least a portion of the information may be displayed on the electronic device. Additionally, or alternatively, at least a portion of the information may be stored within a database (on the electronic device or separate from the device), where the database helps track a user's wear history for the article of clothing.

In some examples, the information is identified by scanning the tag using a camera or sensor of the electronic device. In other examples, the information is identified automatically by the electronic device based on its proximity to a tag on the article of clothing. As described above, the tag may be a smart tag configured to transmit a low-powered signal detectable within a certain limited range of the tag. For example, when a user wears an outfit that is enabled with a powered smart tag, and the electronic device is brought within a certain proximity of the tag, the application on the electronic device will automatically pick up the tags for the clothing the person is wearing and update the user's wear history.

The information may be automatically identified while operating an application on the electronic device. Alternatively, the information may be automatically identified by the electronic device while the application is running in the background of the electronic device (e.g., with Bluetooth or Bluetooth Low Energy enabled).

### Tracking Trends in Clothing

In certain examples, the electronic device may be configured to track trends in clothing based on purchases or wear history of associated users who are sharing their wear history and purchase information through the connected network. In one example, the method includes receiving information from a plurality of electronic devices identifying that users of the plurality of electronic devices are wearing or planning to wear various articles of clothing. The information being received may include a location, time stamp, event, user profile, or combination thereof. The user profile may include an age, height, weight, gender, economic background, or combination thereof. Based on the received information, a processor may determine one or more trends in clothing being worn based on the received information. Additionally, the trend information may be relayed or transmitted back to one or more electronic devices over the connected network. The end user receiving the information may be a clothing designer, a clothing manufacturer, a clothing retailer, an individual user, or combination thereof. This information may be advantageous for these end users in adjusting manufacturing or design processes or purchase decisions.

### Flowchart Embodiments

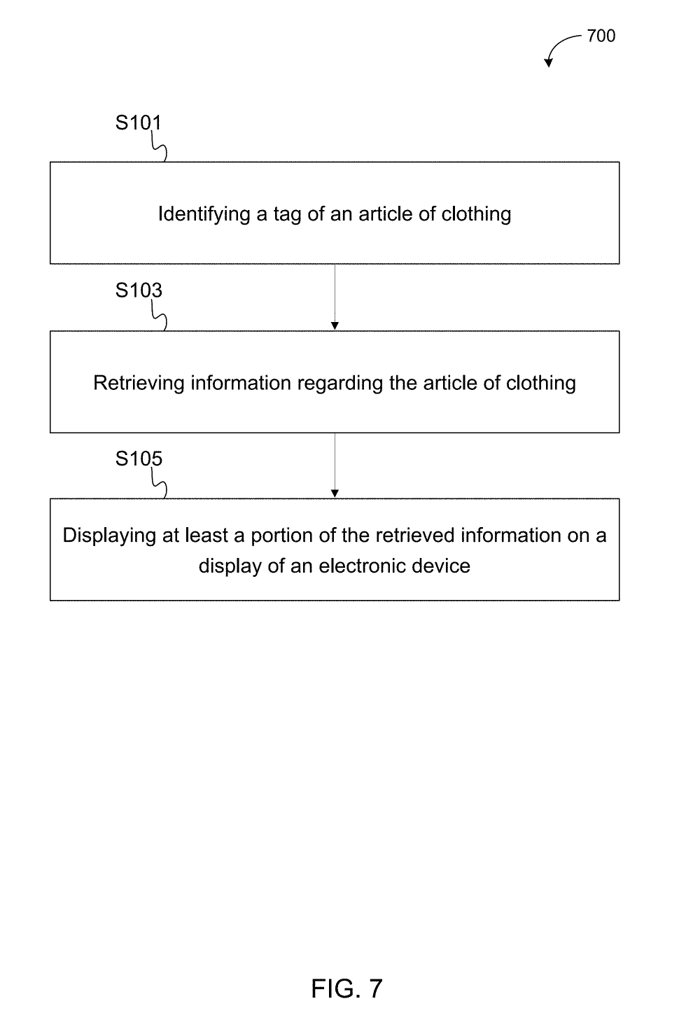

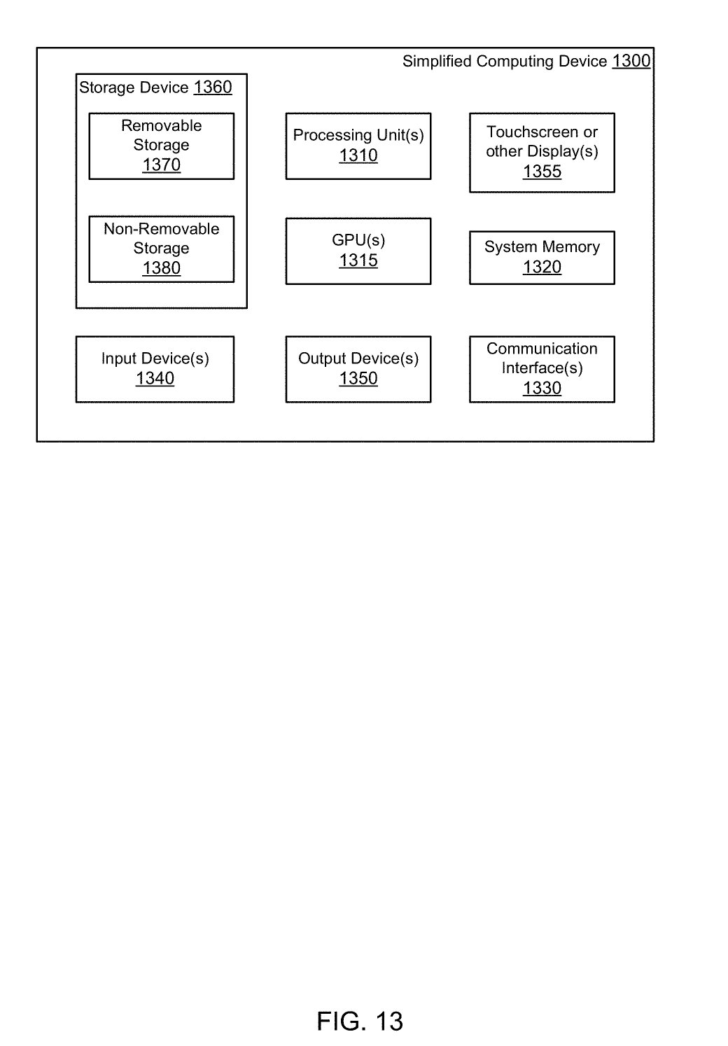

FIGS. 7-12 illustrate example flowchart embodiments for the methods and processes discussed above. The process of the flowchart may be performed by the system or device described and depicted in FIG. 13. Alternatively, another device or system may be configured to perform one or more of the following acts. Additional, fewer, or different acts may be included.

FIG. 7 illustrates an example flowchart 700 for identifying information for an article of clothing. In act S101, a tag of an article of clothing is identified by an electronic device. In act S103, the electronic device retrieves information regarding the article of clothing. In act S105, at least a portion of the retrieved information is displayed on a display of the electronic device.

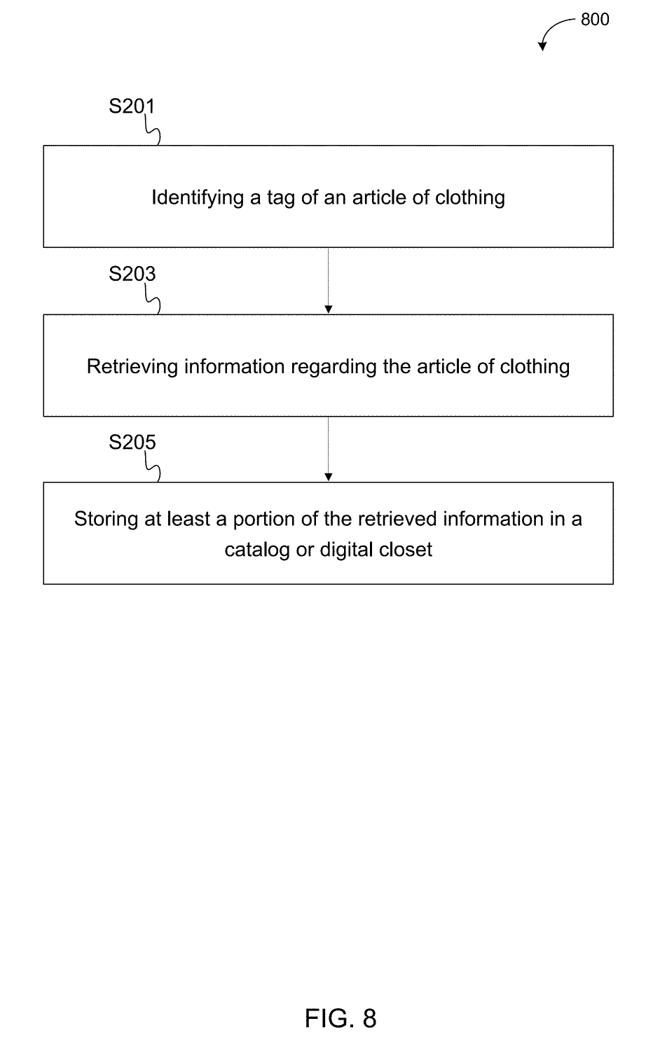

FIG. 8 illustrates an example flowchart 800 for cataloging an article of clothing. In act S201, a tag of an article of clothing is identified by an electronic device. In act S203, the electronic device retrieves information regarding the article of clothing. In act S205, at least a portion of the retrieved information is stored in a catalog or digital closet, wherein the digital closet represents a collection of articles of clothing of a user of the electronic device.

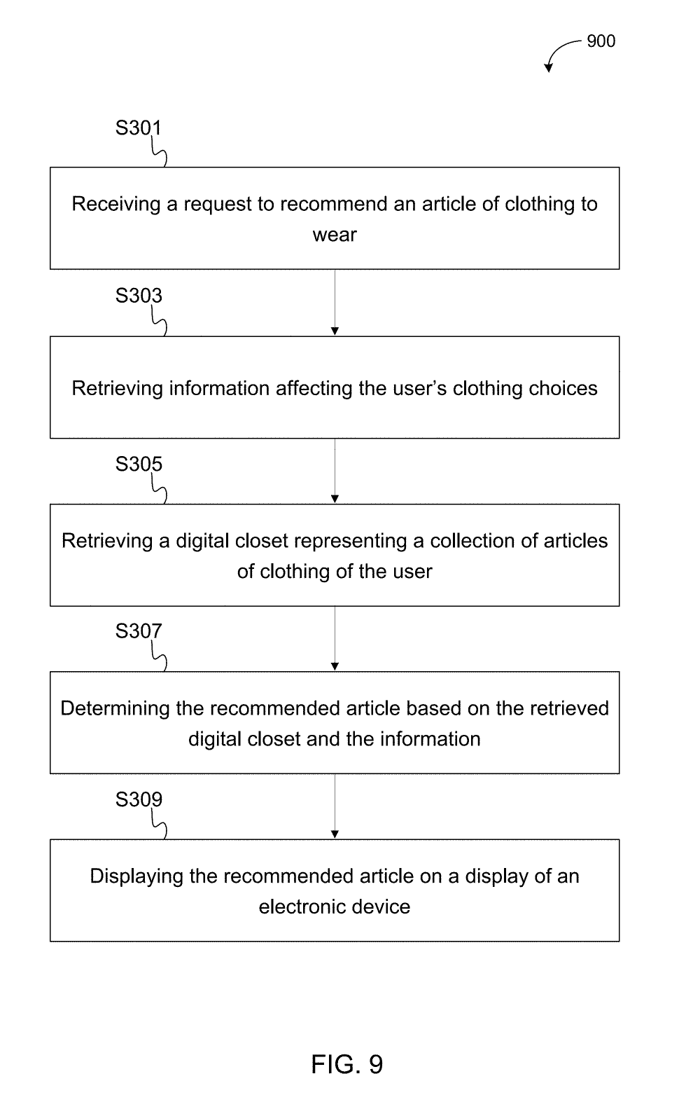

FIG. 9 illustrates an example flowchart 900 for recommending an article of clothing for a user to wear. In act S301, a request is received by an electronic device to recommend an article of clothing to wear. In act S303, the electronic device retrieves information affecting the user's clothing choices. In act S305, the electronic device retrieves a digital closet representing a collection of articles of clothing of the user of the electronic device. In act S307, the electronic device determines the recommended article of clothing based on the digital closet and the information affecting the user's clothing choices. In act S309, the recommended article of clothing is displayed on a display of the electronic device.

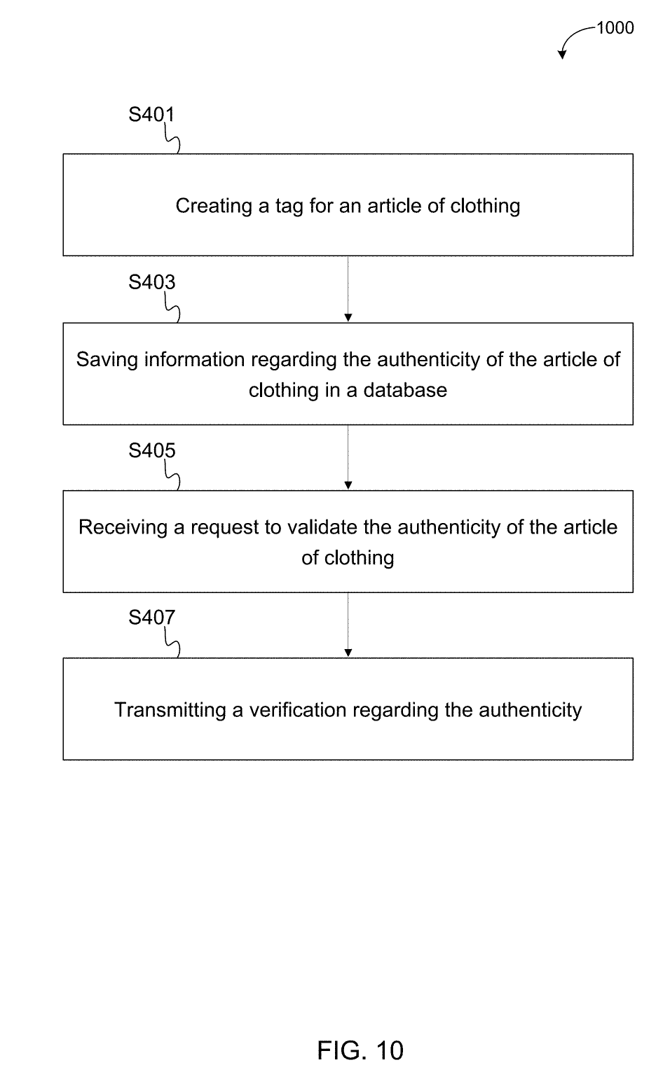

FIG. 10 illustrates an example flowchart 1000 for tracking and authenticating an article of clothing. In act S401, a tag for the article of clothing is created (e.g., printed or manufactured), wherein the tag includes information regarding an authenticity of the article of clothing. In act S403, the information regarding the authenticity of the article of clothing is saved in a database separate from the article of clothing. In act S405, a database receives a request regarding the authenticity of the article of clothing. In act S407, a processor of the database transmits a verification of the authenticity of the article of clothing.

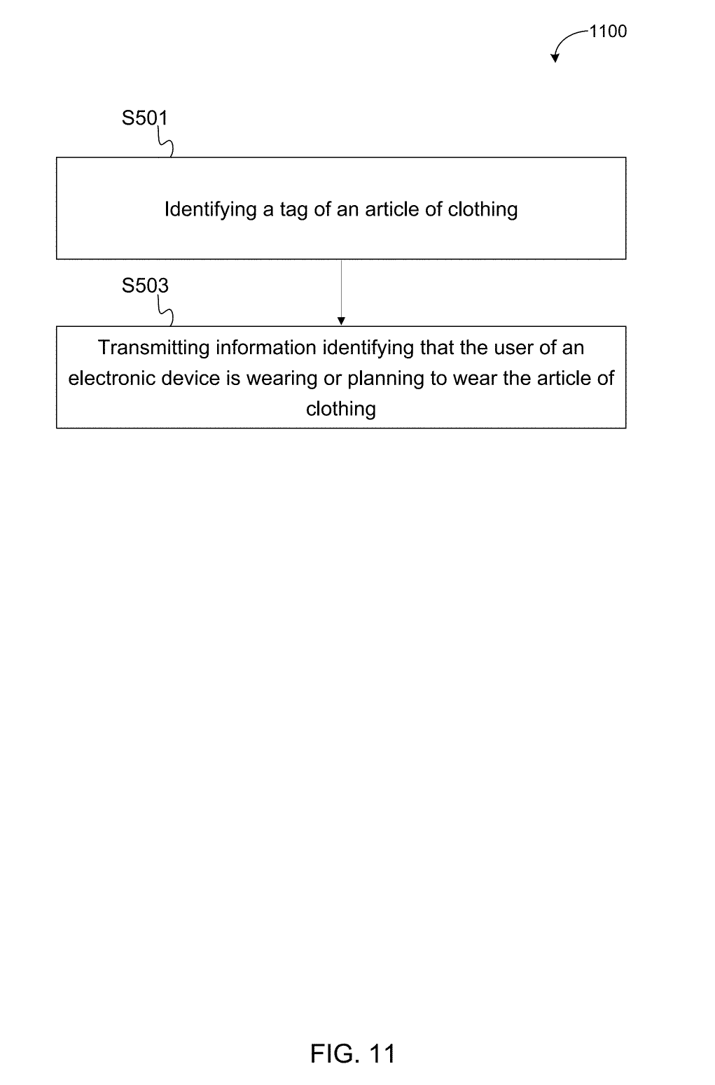

FIG. 11 illustrates an example flowchart 1100 for identifying clothing a user is wearing or planning to wear. In act S501, a tag of an article of clothing is identified by an electronic device. In act S503, the electronic device transmits information identifying that a user of the electronic device is wearing or planning to wear the article of clothing.

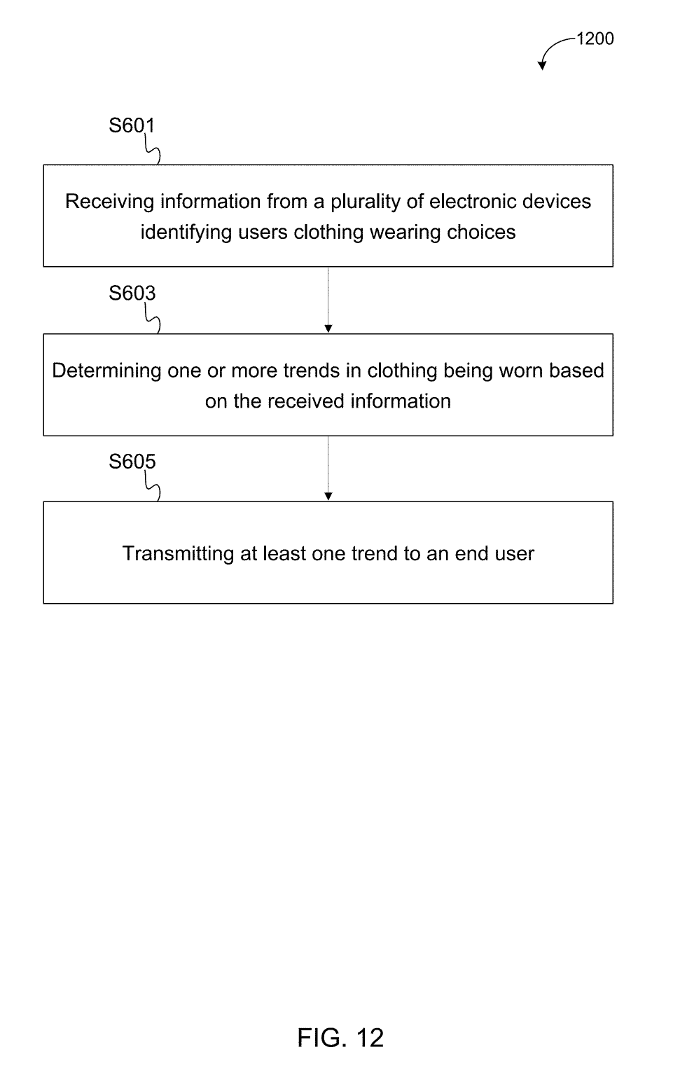

FIG. 12 illustrates an example flowchart 1200 for tracking trends in clothing. In act S601, information is received by a database from a plurality of electronic devices identifying that users of the plurality of electronic devices are wearing or planning to wear various articles of clothing. In act S603, a processor of the database determines one or more trends in clothing being worn based on the received information. In act S605, the processor transmits at least one trend to an end user.

### Computing Environment

Regarding FIG. 13, an electronic device or a processor of a database as described above may be incorporated within an exemplary computing environment 1300. The computing environment 1300 may correspond with one of a wide variety of computing devices, including, but not limited to, personal computers (PCs), server computers, tablet and other handheld computing devices, laptop or mobile computers, communications devices such as mobile phones, multiprocessor systems, microprocessor-based systems, set top boxes, programmable consumer electronics, network PCs, minicomputers, mainframe computers, or audio or video media players. In certain examples, the computing device may be a wearable electronic device, wherein the device may be worn on or attached to a person's body or clothing. The wearable device may be attached to a person's shirt or jacket; worn on a person's wrist, ankle, waist, or head; or worn over their eyes or ears. Such wearable devices may include a watch, heart-rate monitor, activity tracker, or head-mounted display.

The computing environment 1300 has sufficient computational capability and system memory to enable basic computational operations. In this example, the computing environment 1300 includes one or more processing unit(s) 1310, which may be individually or collectively referred to herein as a processor. The computing environment 1300 may also include one or more graphics processing units (GPUs) 1315. The processor 1310 and/or the GPU 1315 may include integrated memory and/or be in communication with system memory 1320. The processor 1310 and/or the GPU 1315 may be a specialized microprocessor, such as a digital signal processor (DSP), a very long instruction word (VLIW) processor, or other microcontroller, or may be a general-purpose central processing unit (CPU) having one or more processing cores. The processor 1310, the GPU 1315, the system memory 1320, and/or any other components of the computing environment 1300 may be packaged or otherwise integrated as a system on a chip (SoC), application-specific integrated circuit (ASIC), or other integrated circuit or system.

The computing environment 1300 may also include other components, such as, for example, a communications interface 1330. One or more computer input devices 1340 (e.g., pointing devices, keyboards, audio input devices, video input devices, haptic input devices, or devices for receiving wired or wireless data transmissions) may be provided. The input devices 1340 may include one or more touch-sensitive surfaces, such as track pads. Various output devices 1350, including touchscreen or touch-sensitive display(s) 1355, may also be provided. The output devices 1350 may include a variety of different audio output devices, video output devices, and/or devices for transmitting wired or wireless data transmissions.

The computing environment 1300 may also include a variety of computer readable media for storage of information such as computer-readable or computer-executable instructions, data structures, program modules, or other data. Computer readable media may be any available media accessible via storage devices 1360 and includes both volatile and nonvolatile media, whether in removable storage 1370 and/or non-removable storage 1380. Computer readable media may include computer storage media and communication media. Computer storage media may include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the processing units of the computing environment 1300.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

While the present claim scope has been described with reference to specific examples, which are intended to be illustrative only and not to be limiting of the claim scope, it will be apparent to those of ordinary skill in the art that changes, additions and/or deletions may be made to the disclosed embodiments without departing from the spirit and scope of the claims.

The foregoing description is given for clearness of understanding only, and no unnecessary limitations should be understood therefrom, as modifications within the scope of the claims may be apparent to those having ordinary skill in the art.

What is claimed is:

1. A method of cataloging an article of clothing, the method comprising:
identifying, by an electronic device, a tag of an article of clothing;
retrieving, by the electronic device, information regarding the article of clothing; and
storing at least a portion of the retrieved information in a catalog representing a collection of articles of clothing of a user of the electronic device.

2. The method of claim 1, wherein the catalog is stored within a memory of the electronic device.

3. The method of claim 1, wherein the catalog is provided in a database separate from the electronic device.

4. The method of claim 1, wherein the information of the article of clothing comprises a product description, a manufacturer, a designer, fabric content, size, brand name, logo, country of origin, wash care instructions, company website uniform resource locator (URL), or combinations thereof.

5. The method of claim 1, further comprising:
defining a level of sharing of the catalog within a network of users.

6. The method of claim 1, further comprising:
combining the catalog of the user with at least one additional catalog of at least one additional user.

7. The method of claim 1, further comprising:
receiving, from the user of the electronic device or a separate electronic device within a shared network, additional information describing the article of clothing; and
appending the catalog with the additional information.

8. The method of claim 7, wherein the additional information represents commentary from the user of the electronic device or a user of the separate electronic device within the shared network.

9. A method of providing a recommended article of clothing for a user to wear, the method comprising:
receiving, by an electronic device, a request to recommend an article of clothing to wear;
retrieving, by the electronic device, information affecting the user's clothing choices;
retrieving, by the electronic device, a digital closet representing a collection of articles of clothing of the user of the electronic device;
determining, by the electronic device, the recommended article of clothing based on the digital closet and the information affecting the user's clothing choices; and
displaying the recommended article of clothing on a display of the electronic device.

10. The method of claim 9, wherein the information affecting the user's clothing choices comprises a location of the user, time of day, day of week, weather, itinerary of the user, user preferences, historical wear patterns, trending patterns on social media, comments on social media, events, or combinations thereof.

11. The method of claim 9, wherein the recommended article of clothing is an article of clothing suggested for purchase to compliment the digital closet.

12. The method of claim 11, further comprising:
providing an option for purchasing the recommended article of clothing on the display of the electronic device or from a physical store within a distance of the electronic device.

13. The method of claim 9, further comprising:
receiving input from a user of the electronic device either accepting or rejecting the recommended article.

14. The method of claim 13, further comprising, following input accepting the recommended article:
adding data regarding the user's wear history of the recommended article.

15. The method of claim 14, further comprising:
transmitting the wear history of the recommended article to a connected database.

16. The method of claim 14, further comprising, following input rejecting the recommended article:
determining, by the electronic device, a new recommended article of clothing based on the digital closet and the information affecting the user's clothing choices; and
displaying the new recommended article of clothing on the display of the electronic device.

17. A method of identifying clothing comprising:
identifying, by an electronic device, a tag of an article of clothing;
transmitting, by the electronic device, information identifying that a user of the electronic device is wearing or planning to wear the article of clothing; and
storing at least a portion of the information in a database configured to track the user's wear history of the article of clothing.

18. The method of claim 17, further comprising:
displaying at least a portion of the information on a display of the electronic device.

19. The method of claim 17, wherein the information is automatically identified by placing the electronic device within a distance of the tag.

20. The method of claim 19, wherein the information is automatically identified while operating an application on the electronic device.
